(19) United States
(12) Patent Application Publication
(10) Pub. No.: US 2008/0124106 A1
(43) Pub. Date: May 29, 2008

(54) OPTICAL BIAS CONTROL METHOD OF INSULATING TONER AND IMAGE FORMING APPARATUS

(76) Inventors: Shigekazu Enoki, Kanagawa (JP); Emiko Shiraishi, Tokyo (JP); Hirokatsu Suzuki, Kanagawa (JP); Jun Yura, Kanagawa (JP); Norimasa Sohmiya, Saitama (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/940,033

(22) Filed: Nov. 14, 2007

(30) Foreign Application Priority Data
Nov. 28, 2006 (JP) 2006-320208

(51) Int. Cl. G03G 15/06

(52) U.S. Cl. 399/55

(57) ABSTRACT

A bias voltage-applying unit applies a bias voltage to an insulating toner that includes an electric charge, by making a contact with the insulating toner. A light irradiating unit irradiates the insulating toner with a light. An electric-charge control unit controls an electric charge amount of the insulating toner by causing an optical switch phenomenon in which an electrostatic charge amount of the insulating toner changes, by irradiating the insulating toner with the light using the light irradiating unit while applying the bias voltage to the insulating toner using the bias voltage-applying unit.

### CROSS-REFERENCE TO RELATED APPLICATIONS

The present application claims priority to and incorporates by reference the entire contents of Japanese priority document, 2006-320208 filed in Japan on Nov. 28, 2006.

### BACKGROUND OF THE INVENTION

1. Field of the Invention

The present invention relates to an image forming apparatus, such as a multifunction product (MFP), a facsimile, and a printer, and an optical bias control method for an insulating toner that is used in the image forming apparatus.

2. Description of the Related Art

Various processes are used to control an electric charge amount of a toner in an image forming apparatus and such processes have developed into significant technologies. In various commonly known electric charge control methods used as one of the technologies mentioned earlier, a photoconductive toner is exposed to light emission to control an electrostatic charge amount. In the electric charge control method that uses light emission, a light intensity can be easily regulated and the electric charge amount can be easily controlled.

For example, in a monocomponent developing device, a toner electric charge amount, which is frictionally electrified by a frictionally electrifying member and supplied for development, becomes unstable due to environment and passage of time. In a technology disclosed in Japanese Patent Application Laid-open No. H9-6132, an electric charge injection is carried out in a photoconductive monocomponent toner by applying a voltage to the monocomponent toner under light emission to control the electric charge amount, and the monocomponent toner is supplied for development.

An effective electric charge control method, which easily enables to control the electric charge amount, is also necessitated for a non-photoconductive insulating toner (hereinafter, simply “insulating toner”). However, even after applying the voltage under light emission to the insulating toner, occurrence of a change in the electric charge amount of the insulating toner has not been observed or assumed until now.

Further, in a technology suggested in Japanese Patent Application Laid-open No. 2005-258323, for controlling the electric charge amount of the toner that is borne on photosensitive drums in a cleanerless system before the toner proceeds towards a charging roller, a toner charge amount-controlling roller is included in an upstream portion of the charging roller and the voltage is applied to the toner charge amount-controlling roller. Further, optical electricity removers are arranged in the vicinity of the toner charge amount-controlling roller for removing electricity from the photosensitive drums. A device suggested in Japanese Patent Application Laid-open No. 2005-258323 includes the toner charge amount-controlling roller as a voltage applying unit and the optical electricity removers that carry out light emission. However, in the device that uses the technology mentioned earlier, the toner charge amount-controlling roller applies the electric charge to the toner and the photosensitive drums, and the optical electricity removers in the vicinity of the toner charge amount-controlling roller remove the electricity from the photosensitive drums that are photoconductive. Due to this, electricity removal and electric discharge are repeated on the photosensitive drums, thus causing a flow of a large number of discharging currents and facilitating electric charge control of the toner on the photosensitive drums. Thus, the electric charge amount of the insulating toner is not changed directly using light emission and voltage application.

### SUMMARY OF THE INVENTION

It is an object of the present invention to at least partially solve the problems in the conventional technology

A method of controlling an electric charge amount of an insulating toner, according to one aspect of the present invention, includes causing an optical switch phenomenon in which an electrostatic charge amount of the insulating toner changes, by irradiating the insulating toner with a light, while making the insulating toner contact with a photoconductive member to which a bias voltage is applied.

An image forming apparatus according to another aspect of the present invention includes an electric-charge control unit including a bias voltage-applying unit that applies a bias voltage to an insulating toner that includes an electric charge, by making a contact with the insulating toner and a light irradiating unit that irradiates the insulating toner with a light. The electric-charge control unit controls an electric charge amount of the insulating toner by causing an optical switch phenomenon in which an electrostatic charge amount of the insulating toner changes, by irradiating the insulating toner with the light using the light irradiating unit while applying the bias voltage to the insulating toner using the bias voltage-applying unit.

An image forming apparatus according to still another aspect of the present invention includes an electric-charge control means including a bias voltage-applying means for applying a bias voltage to an insulating toner that includes an electric charge, by making a contact with the insulating toner and a light irradiating means for irradiating the insulating toner with a light. The electric-charge control means controls an electric charge amount of the insulating toner by causing an optical switch phenomenon in which an electrostatic charge amount of the insulating toner changes, by irradiating the insulating toner with the light using the light irradiating means while applying the bias voltage to the insulating toner using the bias voltage-applying means.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic of an overview of a transfer residual toner-observing device;

FIG. 2 is a graph of a transfer residual toner amount that is expressed as an area ratio of an area before and after the transfer;

FIG. 3 is a graph of an electrostatic charge distribution of the transfer residual toner;

FIG. 4 is a schematic of an experiment for confirming whether the toner is photoconductive;

FIG. 5 is a graph of a comparison of influence that is exerted on the transfer residual toner by titanium oxide and silica as an additive agent;

FIGS. 6A to 6C are graphs that indicate a toner polarity controlling effect due to an optical bias, FIG. 6A is a graph of the electrostatic charge distribution of the transfer residual toner, FIG. 6B is a graph of the electrostatic charge distribution without light emission, and FIG. 6C is a graph of the electrostatic charge distribution with light emission;

FIG. 7 is a graph of a comparison of the transfer residual toners according to colors of a color polymer toner;

FIG. 8 is a schematic of an overview of an image forming apparatus; and

FIG. 9 is a schematic of an overview of an image forming unit.

### DETAILED DESCRIPTION OF THE PREFERRED EMBODIMENTS

Exemplary embodiments of the present invention are explained in detail below with reference to the accompanying drawings. In an embodiment explained below, the present invention is applied to an image forming apparatus.

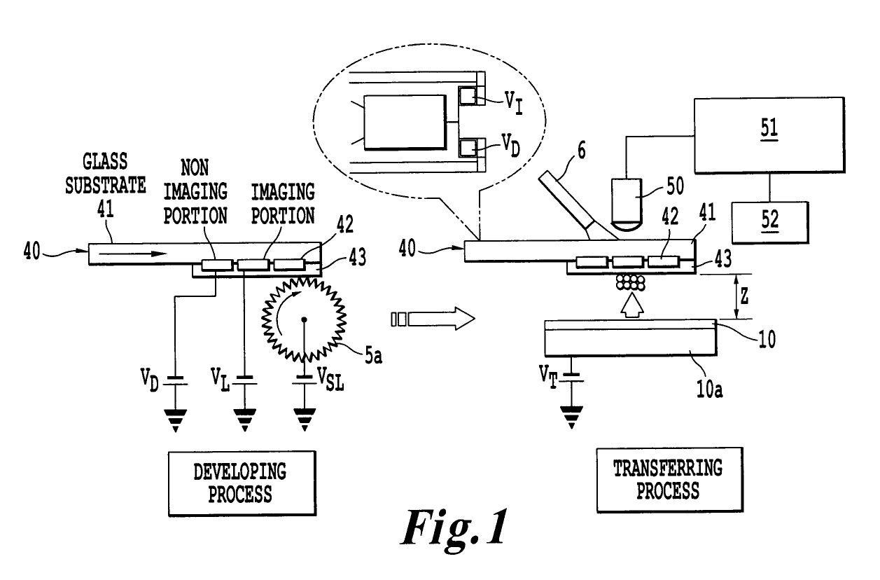

Developments, which led to a discovery of an optical switch phenomenon that is a salient feature of the present invention, are explained first. FIG. 1 is a schematic of an overview of a transfer residual toner-observing device. A sequence of a process which is performed by the transfer residual toner-observing device shown in FIG. 1 to observe a transfer residual toner is explained next. As shown in a developing process shown in FIG. 1, an observation plate 40 that is used as a latent image bearing member includes a glass substrate 41, an indium tin oxide (ITO) electrode 42, and an electrode protecting film 43. The electrode protecting film 43 is arranged on the ITO electrode 42 that is disposed on the glass substrate 41. A developing roller 5a, which bears a bicomponent developer consisting of a carrier and an insulating color polymer toner, develops latent images to get a toner image. A regular charge polarity of the color polymer toner, which is used in the developing process mentioned earlier, is negative. Next, as shown in a transferring process shown in FIG. 1, a transfer electric field, which includes a reverse polarity (positive polarity) with respect to a charge polarity of the toner, is applied to the toner image that is formed on the ITO electrode 42 and the toner image is transferred to a surface of an insulating transfer belt 10. Transfer of the toner image to the transfer belt 10 is observed via the glass substrate 41.

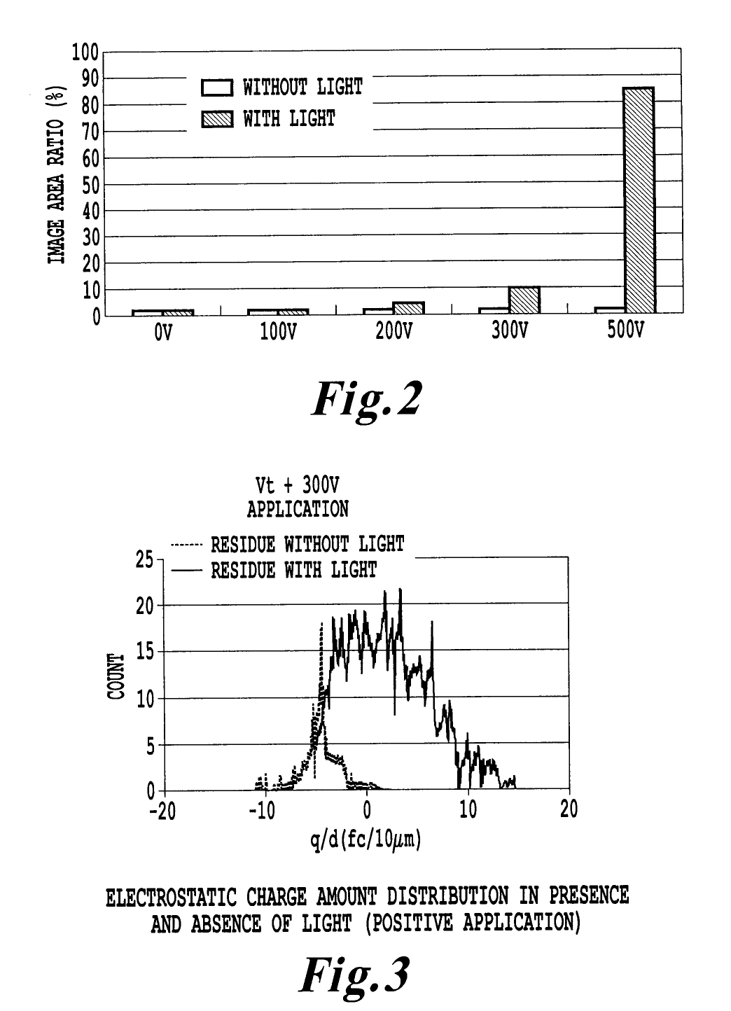

When transferring the toner image, the toner that moves onto the surface of the transfer belt 10 is observed while being exposed to light from a light source 6. A toner amount, which is transferred when the toner is exposed to light, differs from a toner amount that is transferred when the toner is not exposed to light. As shown in FIG. 2, an amount of the transfer residual toner is significant when the toner is exposed to light. The amount of the transfer residual toner is less when the toner is not exposed to light and the toner image is cleanly transferred to the surface of the transfer belt 10.

As shown in FIG. 3, upon checking an electrostatic charge amount distribution, if the toner is exposed to light, the toner of a reverse polarity (positive polarity) component increases. If the toner is not exposed to light, the toner of the reverse polarity component is less. Upon carrying out a similar experiment by changing a color of the toner, similar results were obtained for a portion of the toner that is exposed to light and a portion of the toner that is not exposed to light. For avoiding the influence of heat due to light emission, an observation area is exposed to light that is guided via an optical fiber from a halogen lamp light source wherein a long wavelength is cut, and a temperature of the observation area is regulated within approximately 30° Celsius (C).

Considering the phenomenon mentioned earlier enables to infer that under light emission, an electric charge injection has occurred in the toner due to the transfer electric field that includes the reverse polarity with respect to the regular charge polarity of the toner. Because a structure (the glass substrate 41, the ITO electrode 42, an electrode protecting film 43, the toner, and the transfer belt 10) of the residual toner observing device mentioned earlier is similar to a metal semiconductor (MS) structure in which a metal and a semiconductor come in contact with each other, occurrence of an electric charge injection phenomenon is likely due to a rectifying contact, in other words, due to a rectifying effect resulting from a Schottky Barrier. Further, because a predetermined electric field is applied to the toner, the occurrence of the electric charge injection phenomenon is also likely due to a Poole-Frenkel effect that results from escaping of the carrier that occurs due to a lowering of a Coulomb barrier of a trap. Thus, although the occurrence of the electric charge injection can be attributed to various factors, actual reasons for the occurrence of the electric charge injection in the non-photoconductive toner under light emission are still not clearly understood.

For confirming that the used toner is non-photoconductive, a first experiment is carried out in which the toner image formed on the ITO electrode 42 is put in a dark place and an electrostatic charge of the toner image is measured. Further, in a second experiment, the toner image is subjected to twice the amount of light emission in twice the light emission time period compared to the earlier experiment and the electrostatic charge of the toner image is measured. The electrostatic charge measured in the first experiment does not differ from the electrostatic charge measured in the second experiment. Because a photoconductive toner is commonly known as the toner that responds to light emission, in the second experiment, the electrostatic charge of the photoconductive toner is invariably reduced or lost. Thus, non photoconductivity of the used toner is confirmed. The used toner does not include photoconductive material and is formed of a general polyester resin, a pigment, and electric charge controller.

Because titanium oxide, which is photoconductive, is used as an external additive agent of the toner, for confirming that the used toner is non-photoconductive, experiments similar to the first and the second experiments mentioned earlier are carried out by using the toner that uses non-photoconductive silica as the external additive agent. Similarly as the experiments mentioned earlier, the transfer residual toner increases in the portion that is exposed to light (see FIG. 5). In other words, the electrostatic charge amount of the toner, which includes non-photoconductive materials, seems to change when the toner itself is subjected to application of the voltage and simultaneously subjected to light emission. The electrostatic charge amount of the toner is not affected due to titanium oxide that is photoconductive and that is used as the external additive agent. Such a phenomenon cannot be explained using commonly used knowledge.

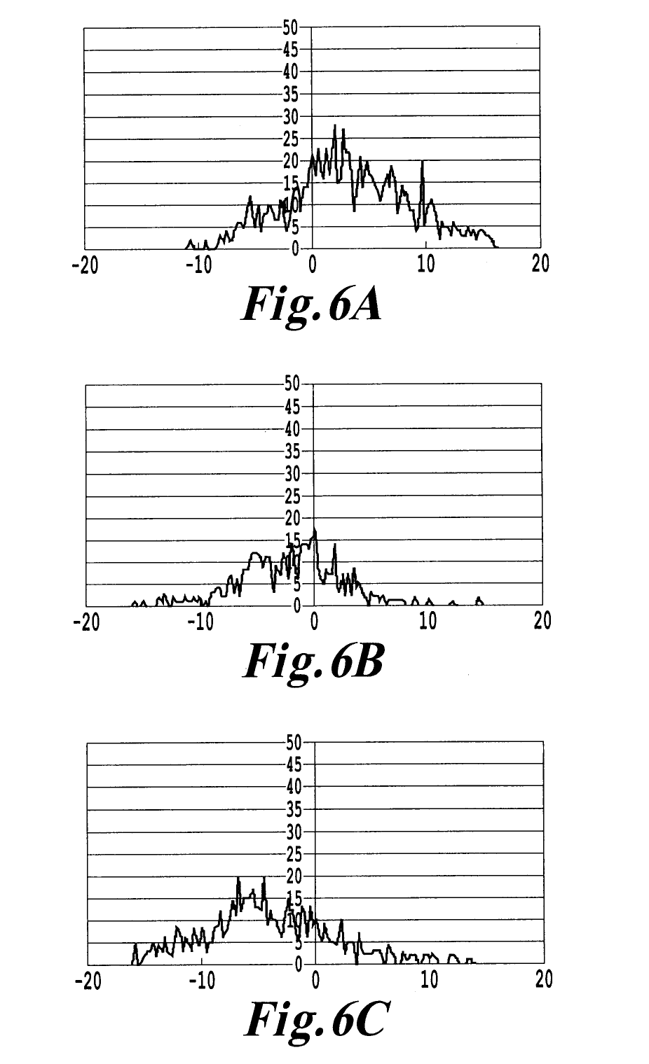

Next, a transfer residual toner image, which includes a significant reverse polarity (positive polarity) component, is formed on the surface of the insulating transfer belt 10, an electric field (negative polarity) is applied that is opposed to the transfer electric field, and the electrostatic charge amount distribution is measured. The electrostatic charge amount distribution is measured when the toner is simultaneously exposed to light emission and when the toner is not exposed to light emission, and the respective results are compared. FIG. 6A is a graph of the electrostatic charge distribution of the formed residual toner image. FIG. 6B is a graph of the electrostatic charge distribution of the residual toner image after applying the electric field that is opposed to the transfer electric field and without exposing the toner to light emission. FIG. 6C is a graph of the electrostatic charge distribution of the residual toner image after applying the electric field that is opposed to the transfer electric field and simultaneously exposing the toner to light emission. In the transfer residual toner that is shown in FIG. 6A and that includes a significant reverse polarity (positive polarity) component, because the toner of the positive polarity component is transferred due to the electric field (negative polarity) that is opposed to the transfer electric field, as shown in FIGS. 6B and 6C, the toner of the negative polarity remains. Upon comparing the respective graphs that are shown in FIGS. 6B and 6C, an amount of a regular charge polarity (negative polarity) component has increased when the toner is exposed to light emission compared to the amount of the regular charge polarity component when the toner is not exposed to light emission. Similarly, a negative electrostatic charge amount has increased when the toner is exposed to light emission compared to the negative electrostatic charge amount when the toner is not exposed to light emission. Results of the experiment mentioned earlier enable to infer that under light emission, the regular charge polarity component has increased as a result of the occurrence of the electric charge injection due to the transfer electric field of the same polarity as the regular charge polarity of the toner. If the results of the experiments which are explained with reference to FIG. 2 are combined with the results of the experiments that are explained with reference to FIGS. 6A to 6C, it can be inferred that by applying the electric field and simultaneously carrying out light emission, the electric charge injection of any one of the positive polarity and the negative polarity can be carried out into the insulating toner. In other words, even if the insulating toner is used, applying the electric field to the transfer residual toner and simultaneously carrying out light emission enables optical bias control that controls the polarity of the transfer residual toner.

Further, in another experiment, the toner is subjected to infrared rays irradiation (to be specific, heating by a nichrome wire heater) instead of light emission and the toner is heated to approximately 40° C. However, the electrostatic charge amount of the toner does not change.

A red laser diode (LD) light is used as a light source instead of the halogen lamp. However, similarly as the phenomenon observed in the earlier experiments, a significant amount of the transfer residual toner remains in the portion that is exposed to light.

Further, a pulverized polyester type toner, which includes a significant styrene acrylic component, is used instead of the polymer toner. However, similarly as the polymer toner that includes polyester as a main component, the effect of light is observed and the transfer residual toner increases in the portion that is exposed to light. In other words, the used toner need not be a specific toner and a commonly used insulating toner can also be used.

Thus, based on the various experiments mentioned earlier, it is clear that upon subjecting the toner to light emission in the electric field, “optical switch phenomenon” that changes the electrostatic charge amount is observed even for the insulating toner. Further, it is also clear that applying the electric field to the insulating toner and simultaneously carrying out light emission enables “optical bias control” that controls the electrostatic charge amount of the insulating toner.

Next, based on a first to a fourth experiments, the optical switch phenomenon and an optical bias control method are explained in further detail.

### First Experiment

As shown in FIG. 1, in the transfer residual toner-observing device, the observation plate 40 is used as the image bearing member. In the observation plate 40, the electrode protecting film 43 is arranged on the ITO electrode 42 that is disposed on the glass substrate 41. The ITO electrode 42 is an electrode that includes a small amount of tin oxide added to indium oxide. A polycarbonate resin (PCZ) is used as the electrode protecting film 43. The toner image is developed by the developing roller 5a on the observation plate 40. Next, the transfer electric field, which is opposed to the regular charge polarity of the toner, is applied to the toner image that is formed on the observation plate 40 and the toner image formed on the ITO electrode 42 is transferred onto the surface of the insulating transfer belt 10. A transfer of the toner is observed using a microscope 51 via the glass substrate 41 of the observation plate 40. Detailed conditions during the transfer are described below.
The glass substrate 41—thickness 5 millimeters (mm)
The ITO electrode 42—thickness 10 nanometers (nm)
Thickness of the protecting film PCZ-6 μm
Material of the transfer belt-polyimide
Type of the light source-halogen or LD
Light intensity-100,000 (Lux) for halogen or an output of 1 milliwatt (mW) for LD (red)

An operation of the transfer residual toner-observing device is explained in detail. In the developing process shown in FIG. 1, a voltage is applied to the ITO electrode 42 such that an electric potential V_{L} equivalent to an imaging portion is −100 volts (V) and an electric potential V_{D} equivalent to a non-imaging portion is −500 V. The latent image on the observation plate 40 is developed at a linear speed of 180 millimeters per second (mm/sec). Approximately 50 milligrams per square centimeters (mg/cm²) of the bicomponent developer, which is formed by mixing 5 percent by weight of insulating cyan polymer toner particles of a volume average grain size of 5.5 μm with carrier particles of a volume average grain size of 55 μm, is stored on the surface of the developing roller 5a. A distance between the surface of the observation plate 40 and the developing roller 5a, in other words, a developing gap is 0.5 mm. A peripheral velocity of the developing roller 5a includes a velocity ratio of 2.0 times with respect to the observation plate 40. Developing is carried out at a developing bias V_{SL} of −450 V and the toner adheres to a latent image area equivalent to the imaging portion. The regular charge polarity of the insulating cyan polymer toner, which is used in the developing process mentioned earlier, is negative.

Next, the observation plate 40 is subjected to the transferring process shown in FIG. 1 and the toner on the observation plate 40 is transferred to the transfer belt 10 to which the electric field is applied. Transfer of the toner to the transfer belt 10 is observed from the glass substrate 41 side of the observation plate 40. The transfer belt 10 is formed of polyimide of a thickness of 0.15 mm and is arranged on a SUS substrate 10a. After the toner image on the observation plate 40 is fixed using a pressure of 7800 Newton per square meter (N/m²), a transfer voltage V_{T} of +100 to +400 V is applied. During the application of the transfer voltage, the toner image is subjected to light emission using the light source 6 and behavior of the toner can be observed. The transfer belt 10, which is adhering to the toner, is pulled away for more than 10 mm and a transfer power source is cut off, thus completing the transferring process.

Using the transfer residual toner-observing device mentioned earlier enables to examine a performance of various types of developers and transfer belt materials. Thus, developers and transfer belt materials that leave less amount of transfer residual toner are developed. For calculating a result of such an experiment, the toner image on the observation plate 40 is retrieved via a lens 50 into the microscope 51 that includes a charge coupled device (CCD), and the toner image is recorded as an image of a video 52. Next, image processing is carried out to calculate an area occupied by the toner in the observation area. The area occupied by the toner before the transfer is compared to the area occupied by the toner after the transfer to calculate a transfer residual toner area.

FIG. 2 is a graph of a transfer residual toner amount that is expressed as an area ratio before and after the transfer and that remains on the observation plate 40 when the toner is subjected to light emission by the light source 6 and when the toner is not subjected to light emission. A horizontal axis indicates the transfer electric field that is a difference between a latent image electric potential and an applied transfer electric potential. As shown in FIG. 2, if the toner is not subjected to light emission, the transfer residual toner amount does not change even if the transfer electric field is increased. However, if the toner is subjected to light emission, the transfer residual toner increases upon the transfer electric field exceeding 200 V and 85 percent of the developed toner remains without getting transferred when the transfer electric field is 500 V. In other words, the transfer residual toner increases along with light emission. Thus, it is clearly understood that a change occurs in the toner due to light emission.

FIG. 3 is a graph of an electrostatic charge distribution of the transfer residual toner when the toner is subjected to light emission and when the toner is not subjected to light emission. The distribution of the electrostatic charge of the transfer residual toner is examined by using an Espert analyzer. If the toner is not subjected to light emission, the electrostatic charge of nearly the entire transfer residual toner remains the same as the original negative polarity. However, upon receiving light emission, the charge polarity of the transfer residual toner swings to the reverse polarity and a ratio of such a swing is more than 50 percent. Thus, from the result mentioned earlier, it is proved that reversing of the toner polarity causes an increase in the transfer residual toner that is shown in FIG. 2.

### Second Experiment

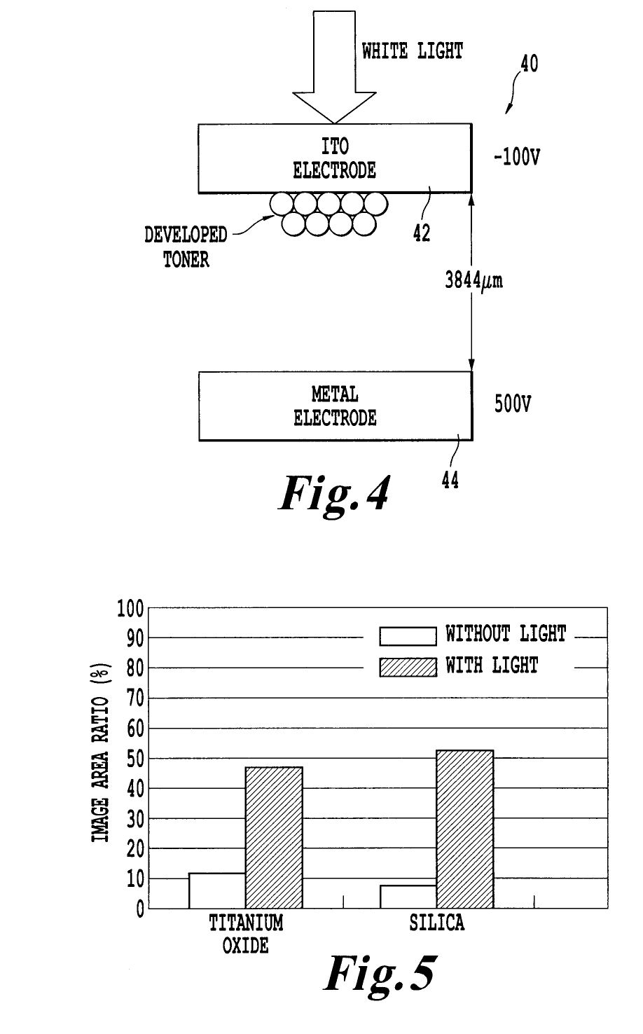

FIG. 4 is a schematic of an experiment for confirming whether the toner mentioned earlier is photoconductive. A developing toner on the ITO electrode 42 applies the transfer electric field of 600 V between the ITO electrode 42 and a metal electrode 44 that is arranged at a position of approximately 4 mm from the ITO electrode 42. A voltage of −100 V is applied to the ITO electrode 42 and a voltage of +500 V is applied to the metal electrode 44. If the toner is photoconductive, a change occurs in a ratio Q/M of the developing toner due to the experiment mentioned earlier. According to a result of the experiment, the ratio Q/M of the developing toner immediately after development is 34.0 μC/g, the ratio Q/M of the developing toner after light emission is 30.2 μC/g, and upon keeping the developing toner in a dark place, the ratio Q/M of the developing toner is 31.2 μC/g. Thus, the result of the experiment does not indicate that the used toner is photoconductive and the change in the ratio Q/M is merely of a level of a measurement error in addition to a natural decrease due to abandonment.

### Third Experiment

FIG. 5 is a graph of a result of examining the influence of titanium oxide as an additive agent of the toner that is likely to be photoconductive. Even if silica is used as the additive agent instead of titanium oxide, any difference is not observed. Thus, it can be inferred that titanium oxide does not exert any influence on the electric charge of the toner under light emission.

### Fourth Experiment

Next, an experiment is carried out to confirm a toner polarity controlling effect due to an optical bias. The toner image is formed on the ITO electrode 42 of the observation plate 40 and the toner image is transferred to the transfer belt 10. The observation plate 40 is subjected to light emission and the transferring process is carried out to ensure that a significant amount of the residual toner remains on the transfer belt 10. The transfer electric field is the same as the transfer electric field of 500 V that is shown in FIG. 2. Next, after cleaning the toner that has adhered to the transfer belt 10, a reverse electric field is once again applied to the transfer residual toner on the ITO electrode 42 at an applied transfer voltage of −600 V. Next, when applying the electric field, results are compared by subjecting the toner to light emission and not subjecting the toner to light emission.

FIGS. 6A to 6C are graphs of a result of the experiment to confirm the toner polarity controlling effect due to the optical bias. FIG. 6A is a graph of the electrostatic charge distribution of the transfer residual toner. FIG. 6B is a graph of the electrostatic charge distribution without light emission. FIG. 6C is a graph of the electrostatic charge distribution with light emission. The positive polarity component has significantly increased in the electrostatic charge distribution of the transfer residual toner shown in FIG. 6A. As shown in FIG. 6B, in the electrostatic charge distribution without light emission, because the toner of the positive polarity component is transferred, the negative polarity toner remains as the residual toner. As shown in FIG. 6C, in the electrostatic charge distribution with light emission, because the toner of the positive polarity component is transferred, the negative polarity toner remains as the transfer residual toner. However, the amount of the negative polarity component has increased compared to the amount of the negative polarity component shown in FIG. 6B when the toner is not subjected to light emission. Further, as shown in FIG. 6C, the electrostatic charge amount on the negative side has also increased compared to the electrostatic charge amount on the negative side that is shown in FIG. 6B. Thus, the result of the experiment indicates that the toner which is positively charged until being subjected to light emission has changed to a strongly negatively charged toner due to light emission. In other words, it can be inferred that simultaneously using light emission in addition to the transfer electric field causes occurrence of the electric charge injection in the toner and causes a toner electric charge to change.

Based on the results of the first experiment and the fourth experiment, it can be inferred that the polarity of the electric charge injection can be any one of the positive polarity or the negative polarity. In other words, upon applying the electric field to the transfer residual toner and simultaneously carrying out light emission, the optical bias control is enabled that controls the polarity of the transfer residual toner. Further, the used toner need not be a specific toner.

The present invention can be applied to the insulating toner that is explained next.

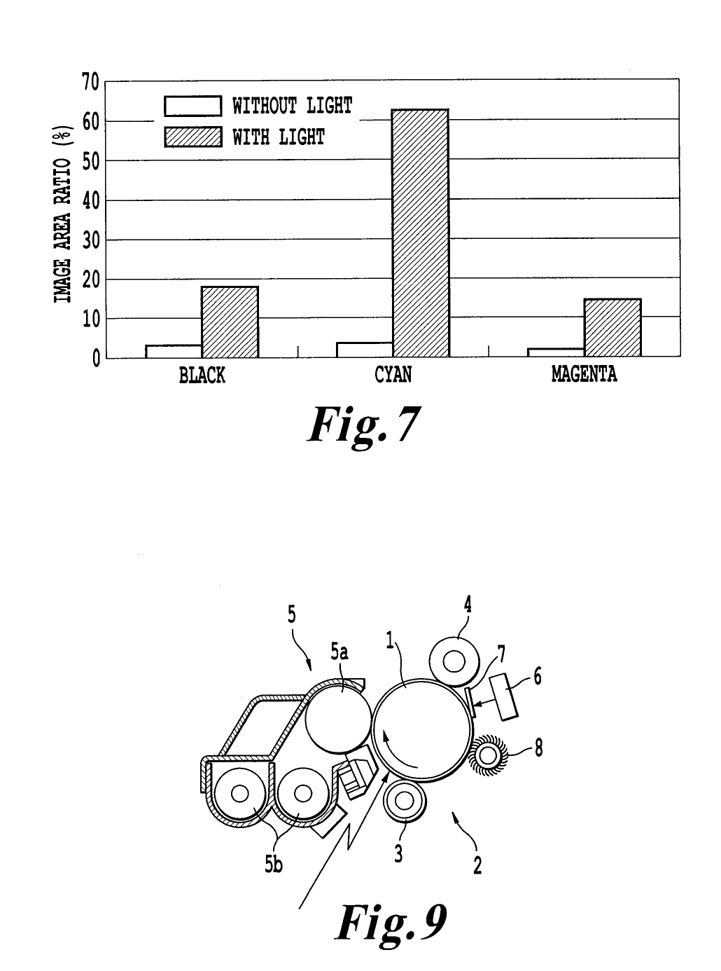

FIG. 7 is a graph of a comparative example of the transfer residual toners that accompany light emission according to colors of the color polymer toner. As shown in FIG. 7, for a cyan toner, the transfer residual toner significantly increases due to light emission. Although a change in the amount of the transfer residual toner is less for a black toner and a magenta toner compared to the cyan toner, the influence of light emission can be observed even for the black toner and the magenta toner. Thus, the optical bias control is not limited to any specific color. Further, instead of using the polymer toner, a similar experiment is carried out by using a thermofusion and pulverization type toner consisting of a resin and a pigment that are formed of the same material components. However, a result of the experiment does not change, thus indicating that the optical bias control is not limited to a specific manufacturing method of the toner.

The polymer toner, which is used in the experiment, is explained next.

For manufacturing the toner, which is suitably used in the image forming apparatus according to the present invention, a toner material solution is prepared by dispersing in an organic solvent, at least a polyester prepolymer that includes a functional group that includes a nitrogen atom, polyester, a coloring agent, and a mold releasing agent. The toner material solution is subjected to any one of a crosslinking reaction or an elongation reaction or both in an aqueous solvent to manufacture the toner. Component materials and a manufacturing method of the toner are explained below.

Polyester is obtained by a polycondensation reaction of a polyhydric alcohol compound and a polycarboxylic compound.

Dihydric alcohols (DIO) and trihydric or higher polyhydric alcohols (TO) are examples of the polyhydric alcohol compounds (PO). (DIO) by itself or a mixture of (DIO) and a small amount of (TO) is desirable as (PIO). Alkylene glycols (ethylene glycol, 1,2-propylene glycol, 1,3-propylene glycol, 1,4-butane diol, 1,6-hexane diol etc.), alkylene ether glycols (diethylene glycol, triethylene glycol, dipropylene glycol, polyethylene glycol, polypropylene glycol, polytetramethylene ether glycol etc.), alicyclic diols (1,4-cyclohexane dimethanol, hydrogenated bisphenol A etc.), bisphenols (bisphenol A, bisphenol F, bisphenol S etc.), alkylene oxide adducts (ethylene oxide, propylene oxide, butylene oxide etc.) of the alicyclic diols mentioned earlier, and alkylene oxide adducts (ethylene oxide, propylene oxide, butylene oxide etc.) of the bisphenols mentioned earlier are examples of dihydric alcohols (DIO). Alkylene glycols of carbon number 2 to 12 and alkylene oxide adducts of bisphenols are desirable as dihydric alcohols. Alkylene oxide adducts of bisphenols and a combination of alkylene oxide adducts of bisphenols and alkylene glycols of carbon number 2 to 12 are especially desirable as dihydric alcohols. Examples of trihydric or higher polyhydric alcohols (TO) are trihydric to octahydric alcohols or higher polyaliphatic alcohols (glycerin, trimethylol ethane, trimethylol propane, pentaerythritol, sorbitol etc.), triphenols or higher polyphenols (such as trisphenol PA, phenol novolac, cresol novolac etc.), and alkylene oxide adducts of the triphenols or higher polyphenols mentioned earlier.

Examples of the polycarboxylic acids (PC) are dicarboxylic acid (DIC) and tricarboxylic or higher polycarboxylic acids (TC). (DIC) by itself or a mixture of (DIC) and a small amount of (TC) is desirable as (PC). Examples of the dicarboxylic acids (DIC) are alkylene dicarboxylic acids (succinic acid, adipic acid, sebacic acid etc.), alkenylene dicarboxylic acids (maleic acid, fumaric acid etc.), aromatic carboxylic acids (phthalic acid, isophthalic acid, terephthalic acid, naphthalene dicarbonic acid etc.). Alkenylene dicarboxylic acids of carbon number 4 to 20 and aromatic dicarboxylic acids of carbon number 8 to 20 are desirable as dicarboxylic acids (DIC). Examples of tricarboxylic or higher polycarboxylic acids (TC) are aromatic polycarboxylic acids of carbon number 9 to 20 (trimellitic acid, pyromellitic acid etc.). Further, causing acid anhydrides of the compounds mentioned earlier, or lower alkyl esters (methyl ester, ethyl ester, isopropyl ester etc.) to react with the polyhydric alcohols (PO) also enables to obtain the polycarboxylic acids (PC).

A ratio of the polyhydric alcohols (PO) and the polycarboxylic acids (PC), which is expressed as an equivalent ratio (OH)/(COOH) of a hydroxyl group (OH) and a carboxyl group (COOH) is normally 2/1 to 1/1. A ratio of 1.5/1 to 1/1 is desirable, and a ratio of 1.3/1 to 1.02/1 is further desirable.

In the polycondensation reaction of the polyhydric alcohols (PO) and the polycarboxylic acids (PC), the polyhydric alcohols (PO) and the polycarboxylic acids (PC) are heated to 150° to 280° C. in the presence of a commonly known esterification catalyst such as tetra butoxy titanate, dibutyltin oxide etc. Pressure is reduced if required and water generated during the reaction is distilled to obtain a polyester that includes a hydroxyl group. A hydroxyl group number of greater than or equal to 5 is desirable for the polyester. An acid number of the polyester is normally 1 to 30, and an acid number of 5 to 20 is desirable. Causing the polyester to include the acid number increases the negative electrostatic charge of the toner. Further, when fixing the toner on a recording sheet, the acid number enhances affinity of the recording sheet and the toner and also enhances low temperature fixability. However, if the acid number exceeds 30, a stability of the electrostatic charge is adversely affected, especially with respect to environmental variations.

A weight average molecular weight of the polyester is 10000 to 400,000 and a weight average molecular weight of 20000 to 200,000 is desirable. A weight average molecular weight of less than 10000 causes anti-offset ability of the toner to deteriorate and is not desirable. Further, the weight average molecular weight exceeding 400,000 causes the low temperature fixability of the toner to deteriorate and is not desirable.

Apart from the unmodified polyester, which is obtained by the polycondensation reaction mentioned earlier, a urea modified polyester is also desirable and included. For obtaining the urea modified polyester, a carboxyl group or a hydroxyl group at the end of the polyester, which is obtained by the polycondensation reaction, is caused to react with a polyisocyanate compound (PIC) to get a polyester prepolymer (A) that includes an isocyanate group. The polyester prepolymer (A) is caused to react with amines and during the reaction, a molecular chain is subjected to any one of the crosslinking reaction or the elongation reaction or both to obtain the urea modified polyester.

Examples of polyisocyanate compounds (PIC) are aliphatic polyisocyanates (tetramethylene diisocyanate, hexamethylene diisocyanate, 2,6-diisocyanatomethyl caproate etc.), alicyclic polyisocyanates (isophorone diisocyanate, cyclohexyl methane diisocyanate etc.), aromatic diisocyanates (tolylene diisocyanate, diphenyl methane diisocyanate etc.), aromatic aliphatic diisocyanates (α,α,α′,α′-tetramethyl xylylene diisocyanate etc.), isocyanates, compounds that are obtained by blocking the polyisocyanates mentioned earlier using phenol derivatives, oximes, caprolactum etc., and combinations of two or more types of the compounds mentioned earlier.

A ratio of the polyisocyanate compounds (PIC) which is expressed as an equivalent ratio (NCO)/(OH) of an isocyanate group (NCO) and a hydroxyl group (OH) of the polyester that includes a hydroxyl group, is normally 5/1 to 1/1. A ratio of 4/1 to 1.2/1 is desirable, and a ratio of 2.5/1 to 1.5/1 is further desirable. If the ratio of (NCO)/(OH) exceeds 5, the low temperature fixability of the toner deteriorates. If a mole ratio of (NCO) is less than one, when using the urea modified polyester, a urea content in the polyester decreases and the anti-offset ability of the toner deteriorates.

An amount of the polyisocyanate compound (PIC) component in the polyester prepolymer (A) that includes an isocyanate group is normally 0.5 to 40 percent by weight. An amount of 1 to 30 percent by weight is desirable, and an amount of 2 to 20 percent by weight is further desirable. If the amount of the polyisocyanate compound (PIC) component is less than 0.5 percent by weight, the anti-offset ability of the toner deteriorates and maintaining a balance between heat resistant storability and the low temperature fixability of the toner becomes difficult. Further, if the amount of the polyisocyanate compound (PIC) component exceeds 40 percent by weight, the low temperature fixability of the toner deteriorates.

A number of isocyanate groups included in the polyester prepolymer (A) per molecule is normally greater than or equal to one. An average of 1.5 to 3 isocyanate groups per molecule are desirable and an average of 1.8 to 2.5 isocyanate groups per molecule are further desirable. If the number of isocyanate groups per molecule is less than one, a molecular weight of the urea modified polyester decreases and the anti-offset ability of the toner deteriorates.

Examples of amines (B) which are caused to react with the polyester prepolymer (A) are diamine compounds (B1), triamines or higher polyamine compounds (B2), amino alcohols (B3), amino mercaptans (B4), amino acids (B5), and compounds (B6) in which amino groups of B1 to B5 are blocked.

Examples of the diamine compounds (B1) are aromatic diamines (phenylene diamine, diethyl toluene diamine, 4,4′-diamineodiphenyl methane etc.), alicyclic diamines (4,4′-diamino-3,3′-dimethyl dicyclohexyl methane, diamine cyclohexane, isophorone diamine etc.), and aliphatic diamines (ethylene diamine, tetramethylene diamine, hexamethylene diamine etc.). Examples of the triamines or higher polyamine compounds (B2) are diethylene triamine and triethylene tetramine. Examples of the amino alcohols (B3) are ethanolamine and hydroxyethyl aniline. Examples of the amino mercaptans (B4) are aminoethyl mercaptan and aminopropyl mercaptan. Examples of the amino acids (B5) are aminopropionic acid and aminocaproic acid. Ketimine compounds and oxazolidine compounds, which are obtained from the amines B1 to B5 mentioned earlier and ketones (acetone, methyl ethyl ketone, methyl isobutyl ketone etc.), are examples of the compounds (B6) wherein the amino groups of B1 to B5 are blocked. Among the amines (B), the diamine compounds of B1 and the compounds that include B1 and a small amount of B2 are desirable.

A ratio of the amines (B), which is expressed as an equivalent ratio (NCO)/(NHx) of an isocyanate group (NCO) from the polyester prepolymer (A) that includes the isocyanate group and an amino group (NHx) from the amines (B), is normally 1/2 to 2/1. A ratio of 1.5/1 to 1/1.5 is desirable, and a ratio of 1.2/1 to 1/1.2 is further desirable. If the ratio (NCO)/(NHx) becomes greater than 2 or less than ½, the molecular weight of the urea modified polyester is reduced and the anti-offset ability of the toner deteriorates.

The urea modified polyester can also include urethane linkages along with urea linkages. A mole ratio of an amount of the urea linkages and an amount of the urethane linkages is normally 100/0 to 10/90. A mole ratio of 80/20 to 20/80 is desirable and a mole ratio of 60/40 to 30/70 is further desirable. If the mole ratio of the urea linkages is less than 10 percent, the anti-offset ability of the toner deteriorates.

The urea modified polyester is manufactured using a one shot method etc. The polyhydric alcohols (PO) and the polycarboxylic acids (PC) are heated to 150° to 280° C. in the presence of a commonly known esterification catalyst such as tetra butoxy titanate, dibutyltin oxide etc. Pressure is reduced if required and water generated during the reaction is distilled to obtain the polyester that includes the hydroxyl group. Next, the polyester is caused to react with polyisocyanate (PIC) at 400 to 140° C. to get the polyester prepolymer (A) that includes an isocyanate group. Next, the polyester prepolymer (A) is caused to react with the amines (B) at 0 to 140° C. to get the urea modified polyester.

When causing the polyester to react with (PIC) and when causing (A) to react with (B), a solvent can also be used if required. Examples of the solvents that can be used are aromatic solvents (toluene, xylene etc.), ketones (acetone, methyl isobutyl ketone etc.), esters (ethyl acetate etc.), amides (dimethyl formamide, dimethyl acetoamide etc.), and ethers (tetrahydrofuran etc.) that are inactive with respect to the isocyanates (PIC).

Further, during any one of the crosslinking reaction or the elongation reaction or both between the polyester prepolymer (A) and the amines (B), a reaction terminator can also be used if required and the molecular weight of the obtained urea modified polyester can be regulated. Examples of the reaction terminator are monoamines (diethylamine, dibutylamine, butylamine, laurylamine etc.) and compounds (ketimine compounds) in which the monoamines are blocked.

The weight average molecular weight of the urea modified polyester is normally greater than or equal to 10,000. A weight average molecular weight of 20,000 to 100,000,000 is desirable and a weight average molecular weight of 30,000 to 1,000,000 is further desirable. If the weight average molecular weight of the urea modified polyester is less than 10,000, the anti-offset ability of the toner deteriorates. When using the unmodified polyester, a number average molecular weight of the urea modified polyester is not especially limited, and any number average molecular weight that is easily converted into the weight average molecular weight can be used. When using the urea modified polyester by itself, the number average molecular weight of the urea modified polyester is normally 2,000 to 15,000. A number average molecular weight of 2,000 to 10,000 is desirable and a number average molecular weight of 2,000 to 8,000 is further desirable. The number average molecular weight of the urea modified polyester exceeding 20,000 results in deterioration of the low temperature fixability and the gloss of the toner when the toner is used in a full color device.

Using a combination of the unmodified polyester and the urea modified polyester enables to enhance the low temperature fixability of the toner and the gloss when the toner is used in a full color image forming apparatus 100. Thus, using a combination of the unmodified polyester and the urea modified polyester is desirable than using the urea modified polyester by itself. Further, the unmodified polyester can also include polyester that is modified using chemical linkages other than the urea linkages.

At least a portion of the unmodified polyester and the urea modified polyester being mutually compatible is desirable for the low temperature fixability and the anti-offset ability. Thus, a similar composition of the unmodified polyester and the urea modified polyester is desirable.

A weight ratio of the unmodified polyester and the urea modified polyester is normally 20/80 to 95/5. A weight ratio of 70/30 to 95/5 is desirable, a weight ratio of 75/25 to 95/5 is further desirable, and a weight ratio of 80/20 to 93/7 is especially desirable. If the weight ratio of the urea modified polyester is less than 5 percent, the anti-offset ability of the toner deteriorates and maintaining a balance between heat resistant storability and the low temperature fixability of the toner becomes difficult.

A glass transition point (T_{g}) of a binder resin that includes the unmodified polyester and the urea modified polyester is normally 45° C. to 65° C. A glass transition point of 45° C. to 60° C. is desirable. If the glass transition point is less than 45° C., a heat resistance of the toner deteriorates. If the glass transition point exceeds 65° C., the low temperature fixability of the toner becomes insufficient.

Because the urea modified polyester is likely to remain on the surface of the obtained parent toner particles, regardless of the low glass transition point, heat resistant storability of the toner is favorable compared to a commonly known polyester type toner.

All commonly known dyes and pigments can be used as colorants. Examples of the colorants that can be used are carbon black, nigrosine dye, iron black, naphthol yellow S, hansa yellow (10G, 5G, G), cadmium yellow, yellow iron oxide, yellow ocher, chrome yellow, titanium yellow, polyazo yellow, oil yellow, hansa yellow (GR, A, RN, R), pigment yellow L, benzidine yellow (G, GR), permanent yellow (NCG), vulcan fast yellow (5G, R), tartrazine lake, quinoline yellow lake, anthrazane yellow BGL, isoindolinone yellow, red iron oxide, minium, red lead, cadmium red, cadmium mercury red, antimony vermilion, permanent red 4R, para red, fire red, parachloro-ortho-nitroaniline red, lithol fast scarlet G, brilliant fast scarlet, brilliant carmine BS, permanent red (F2R, F4R, FRL, FRLL, F4RH), fast scarlet VD, vulcan fast rubin B, brilliant scarlet G, lithol rubin GX, permanent red F5R, brilliant carmine 6B, pigment scarlet 3B, Bordeaux 5B, toluidine maroon, permanent bordeaux F2K, helio Bordeaux BL, Bordeaux 10B, BON maroon light, BON maroon medium, eosin lake, rhodamine lake B, rhodamine lake Y, alizarin lake, thioindigo red B, thioindigo maroon, oil red, quinacridone red, pyrazolone red, polyazo red, chrome vermilion, benzidine orange, perinone orange, oil orange, cobalt blue, cerulean blue alkali blue lake, peacock blue lake, Victoria blue lake, metal-free phthalocyanine blue, phthalocyanine blue, fast sky blue, indanthrene blue (RS, BC), indigo, ultramarine blue, Prussian blue, anthraquinone blue, fast violet B, methyl violate lake, cobalt purple, Manganese purple, dioxane violate, anthraquinone violet, chrome green, zinc green, chrome oxide, pyridian, emerald green, pigment green B, naphthol green B, green gold, acid green lake, malachite green lake, phthalocyanine green, anthraquinone green, titanium oxide, zinc white, lithopone and mixtures of the colors mentioned earlier. A colorant content is normally 1 to 15 percent by weight with respect to the toner, and a colorant content of 3 to 10 percent by weight is desirable.

The colorant can also be used as a master batch that is combined with the resin. Styrenes such as polystyrene, poly-p-chlorostyrene, polyvinyl toluene, substitute polymers of the styrenes mentioned earlier, copolymers of the styrenes mentioned earlier with vinyl compounds, polymethyl methacrylate, polybutyl methacrylate, polyvinyl chloride, polyvinyl acetater, polyethylene, polypropylene, polyester, epoxy resin, epoxypolyol resin, polyurethane, polyamide, polyvinyl butylal, polyacrylic acid resin, rodine, modified rodine, terpene resin, aliphatic or alicyclic hydrocarbon resin, aromatic petroleum resin, chlorinated paraffin, paraffin wax etc. are examples of the binder resins that are used in the manufacture of the master batch or that are mixed with the master batch. The binder resins mentioned earlier can be used independently or as a mixture.

Commonly known electric charge controllers can be used. Examples of the electric charge controllers are nigrosine dyes, triphenyl methane dyes, chromium-containing metal complex dyes, chelate molybdate pigment, rhodamine dyes, alkoxy amine, quaternary ammonium salt (includes fluorine modified quaternary ammonium salt), alkyl amide, phosphorus in element or compound form, tungsten in element or compound form, fluorine series activator, salicylic acid metal salt and metal salt of salicylic acid derivative. Specific examples of the electric charge controllers are bontron 03 that is a nigrosine series dye, bontron P-51 that is a quaternary ammonium salt, bontron S-34 that is a metal-containing azo dye, E-82 that is an oxynaphthoe acid metal complex, E-84 that is a salicylic acid metal complex, E-89 that is a phenol condensate (the chemicals mentioned earlier are manufactured by Orient Chemical Industries), TP-302 that is a quaternary ammonium salt molybdenum complex, TP-415 (the chemicals mentioned earlier are manufactured by Hodogaya Chemicals Company), copy charge PSY VP2038 that is a quaternary ammonium salt, copy blue PR that is a triphenyl methane derivative, copy charge NEG VP2036 that is a quaternary ammonium salt, copy charge NX VP434 (the chemicals mentioned earlier are manufactured by Hochst Company), LRA-901, LR-147 that is a boron complex (manufactured by Japan Carlit Company), copper phthalocyanine, perylene, quinacridone, azo type pigment, and other polymeric compounds that include functional groups such as sulfonic acid group, carboxyl group, quaternary ammonium salt etc. Among the materials mentioned earlier, the materials that especially control the toner to the negative polarity are desirably used. A usage amount of the electric charge controller is decided according to a toner manufacturing method that includes a type of the binder resin, presence of the additive agent that is used if necessary, a dispersion method etc. Thus, the usage amount of the electric charge controller is not uniquely limited. However, the usage amount in a range of 0.1 to 10 parts by weight of the electric charge controller with respect to 100 parts by weight of the binder resin is desirably used. A range of 0.2 to 5 parts by weight of the electric charge controller is desirable. If the usage amount of the electric charge controller exceeds 10 parts by weight, the excess electrostatic charge of the toner reduces the effect of the electric charge controller and increases the electrostatic attraction between the toner and the developing roller. Due to this, fluidity of the developer and image density are reduced.

When dispersed with the binder resin, wax which includes a low melting point of 50° C. to 120° C. functions effectively as the mold releasing agent between a fixing roller and a toner surface. Due to this, wax is effective against heat offset and removes a necessity to coat the fixing roller with the mold releasing agent. Examples of materials, which are used as a wax component, are described below. Examples of wax materials are plant wax such as carnauba wax, cotton wax, wood wax, rice wax etc., animal wax such as beeswax, lanolin etc., mineral wax such as ozokerite, cercine etc., and petroleum wax such as paraffin, microcrystalline, petrolatum etc. Further, apart from natural wax mentioned earlier, synthetic hydrocarbon wax such as Fischer-Tropsch wax, polyethylene wax, and synthetic wax such as ester, ketone, and ether can also be used. Further, fatty amides such as 1,2-hydroxystearic acid amide, stearic acid amide, phthalic anhydride imide, chlorinated hydrocarbon, and crystalline polymer molecules that include a long alkyl group in a side chain, in other words, polyacrylate homopolymers or copolymers (for example, copolymers of n-stearyl acrylate-ethyl methacrylate etc.) such as poly-n-stearyl methacrylate, poly-n-lauryl methacrylate can also be used.

The electric charge controller and the mold releasing agent can also be melted and mixed with the master batch and the binder resin. Further, the electric charge controller and the mold releasing agent can also be added when the master batch and the binder resin are dissolved and dispersed in the organic solvent.

Inorganic particles are desirably used as the external additive agent for supplementing fluidity, developability, and electrostatic charge of the toner. A primary particle diameter of 5×10⁻³ to 2 (μm) is desirable for the inorganic particles and a primary particle diameter of 5×10⁻³ to 0.5 (μm) is further desirable. Further, a specific surface area of 20 to 500 (m²/g) according to Brunauer Emmet Teller (BET) method is desirable for the inorganic particles. A usage percentage of 0.01 to 5 percent by weight of the toner is desirable for the inorganic particles and a usage percentage of 0.01 to 2.0 percent by weight is especially desirable.

Specific examples of the inorganic particles are silica, alumina, titanium oxide, barium titanate, magnesium titanate, calcium titanate, strontium titanate, zinc oxide, tin oxide, silica sand, clay, mica, silica apatite, diatomite, chromium oxide, serium oxide, colcothar, antimony trioxide, magnesium oxide, zirconium oxide, barium sulphate, barium carbonate, calcium carbonate, silicon carbide, silicon nitride etc. Especially, using a combination of hydrophobic silica particles and hydrophobic titanium oxide particles as a fluidity enhancer is desirable. Especially, if hydrophobic silica particles and hydrophobic titanium oxide particles having an average particle diameter of less than or equal to 5×10⁻² (μm) are mixed by stirring, electrostatic power and van der Waals power of the toner are significantly enhanced. Due to this, the fluidity enhancer is not detached from the toner even if the fluidity enhancer is mixed by stirring inside a developing device for getting a desired electrostatic charge level. Thus, a better image quality can be obtained by preventing occurrence of dots and the transfer residual toner can be reduced.

Although using the titanium oxide particles is desirable for better environmental stability and image density stability, because a charge rising property of the toner increasingly deteriorates, if an additive amount of the titanium oxide particles becomes more than an additive amount of the silica particles, influence of the side effect mentioned earlier is likely to increase. However, if the additive amounts of the hydrophobic silica particles and the hydrophobic titanium oxide particles are in a range of 0.3 to 1.5 percent by weight, the charge rising property of the toner is not significantly affected and a desired charge rising property can be obtained. In other words, a stable image quality can be obtained even if the image is repeated copied.

The manufacturing method of the toner is explained next. Although the manufacturing method explained below is desirable, the present invention is not to be thus limited.

First, the coloring agent, the unmodified polyester, the polyester prepolymer that includes an isocyanate group, and the mold releasing agent are dispersed in the organic solvent to form the toner material solution.

A volatile organic solvent having a boiling point of less than 100° C. is desirable for easy removal of the organic solvent after formation of the parent toner particles. To be specific, toluene, xylene, benzene, tetrachlorocarbon, chloromethylene, 1,2-dichloroethane, 1,1,2-trichloroethane, trichloroethylene, chloroform, monochlorobenzene, dichloroethylidene, methyl acetate, ethyl acetate, methyl ethyl ketone, methyl isobutyl ketone etc. can be used alone or a combination of two or more chemicals mentioned earlier can be used. Especially, aromatic solvents such as toluene, xylene and halogenated hydrocarbons such as chloromethylene, 1,2-dichloroethane, chloroform, tetrachlorocarbon are desirable. A usage amount of the organic solvent is normally 0 to 300 parts by weight of the organic solvent with respect to 100 parts by weight of the polyester prepolymer. A usage amount of 0 to 100 parts by weight of the organic solvent is desirable and a usage amount of 25 to 70 parts by weight of the organic solvent is further desirable.

Next, the toner material solution is emulsified in the aqueous solvent in the presence of a surface active agent and resin particles.

Water alone can be used as the aqueous solvent. Further, aqueous solvents that include organic solvents such as alcohols (methanol, isopropyl alcohol, ethylene glycol etc.), dimethyl formamide, tetrahydrofuran, cellosolves (methyl cellosolve etc.), lower ketones (acetone, methyl ethyl ketone etc.) can also be used.

A usage amount of the aqueous solvent is normally 50 to 2000 parts by weight of the aqueous solvent with respect to 100 parts by weight of the toner material solution. A usage amount of 100 to 1000 parts by weight of the aqueous solvent is desirable. If the usage amount of the aqueous solvent becomes less than 50 parts by weight, the dispersed state of the toner material solution deteriorates and toner particles of a predetermined particle diameter cannot be obtained. If the usage amount of the aqueous solvent exceeds 20000 parts by weight, toner manufacturing is not economical.

A dispersing agent such as the surface active agent or the resin particles is suitably added for enhancing the dispersion in the aqueous solvent. Examples of the surface active agent are anionic surface active agents such as alkylbenzene sulfonate, α-olefine sulfonate, ester phosphate, amine salts such as alkylamine salts, amino alcohol fatty acid derivatives, polyamine fatty acid derivatives, imidazolin, cationic surface active agent of quaternary ammonium salt type such as alkyl trimethyl ammonium salt, dialkyl dimethyl ammonium salt, alkyl dimethyl benzyl ammonium salt, pyridium salt, alkyl isoquinolium salt, chlorobenzetonium, nonionic surface active agent such as fatty acid amide derivatives, polyhydric alcohol derivatives, and zwitterionic surface active agent such as alanine, dodecyldi (aminoethyl) glycine, di(octylaminoethyl) glycine, N-alkyl-N,N-dimethyl ammonium betaine.

Using the surface active agent that includes a fluoroalkyl group enables to enhance the effect of the surface active agent using an extremely small amount of the surface active agent. Examples of desirably used anionic surface active agents that include a fluoroalkyl group are fluoroalkyl carboxylic acids of carbon number 2 to 10 and metal salts of the fluoroalkyl carboxylic acids, perfluorooctane sulfonyl dinatrium gultaminate, 3-(w-fluoroalkyl (C6 to C1) oxy)-1-alkyl (C3 to C4) natrium sulfonate, 3-(w-fluoroalkanoyl (C6 to C8)-N-ethylamino)-1-propane natrium sulfonate, fluoroalkyl (C1 to C20) carboxylic acid and metal salts of fluoroalkyl (C1 to C20) carboxylic acid, perfluoroalkyl carboxylic acid (C7 to C13) and metal salts of perfluoroalkyl carboxylic acid (C7 to C13), perfluoroalkyl (C4 to C12) sulfonic acid and metal salts of perfluoroalkyl (C4 to C12) sulfonic acid, perfluorooctane sulfonic acid diethanol amide, N-propyl-N-(2-hydroxyethyl perfluorooctane sulfonic amide, perfluoroalkyl (C6 to C10) sulfonic amide propyl trimethyl ammonium salt, perfluoroalkyl (C6 to C10)-N-ethylsulfonyl glycine salt, monoperfluoroalkyl (C6 to C16) ethyl phosphoric acid ester etc.

Examples of product names are saflon S-111, S-112, S-113 (manufactured by Asahi Glass Company), flolard FC-93, FC-95, FC-98, FC-129 (manufactured by Sumitomo 3M Company), unidine DS-101, DS-102 (manufactured by Daikin Industries Company), megafac F-110, F-120, F-113, F-191, F-812, F-833 (manufactured by Dai Nihon Ink Company), ektop EF-102, 103, 104, 105, 112, 123A, 123B, 306A, 501, 201, 204 (manufactured by Tohkem Products Company), futargent F-100, F-150 (manufactured by Neos Company) etc.

Examples of the cationic surface active agent are aliphatic primary or secondary amino acids that include a fluoroalkyl group, aliphatic quaternary ammonium salts such as perfluoroalkyl (C6 to C10) sulfonic amide propyl trimethyl ammonium salt, benzalkonium salt, benzetonium chloride, pyridium salt, and imidazolium salt. Examples of product names are saflon S-121 (manufactured by Asahi Glass Company), flolard FC-135 (manufactured by Sumitomo 3M Company), unidine DS-202 (manufactured by Daikin Industries Company), megafac F-150, F-824 (manufactured by Dai Nihon Ink Company), ektop EF-132 (manufactured by Tohkem Products Company), and futargent F-300 (manufactured by Neos Company) etc.

The resin particles are added for stabilizing the parent toner particles that are formed in the aqueous solvent. To stabilize the parent toner particles, the resin particles are desirably added such that a surface coverage of the resin particles on the surface of the parent toner particles is in a range of 10 to 90 percent. Examples of the resin particles are methyl polymethacrylate particles of 1 (μm) and 3 (μm), polystyrene particles of 0.5 (μm) and 2 (μm), poly (styrene-acryronitrile) particles of 1 (μm) etc. Examples of product names are PB-200H (manufactured by Kao Company), SGP (manufactured by Soken Company), technopolymer-SB (manufactured by Sekisui Plastics Company), SGP-3G (manufactured by Soken Company), micropearl (manufactured by Sekisui Fine Chemicals Company) etc. Further, inorganic compound dispersing agents such as tricalcium phosphate, calcium carbonate, titanium oxide, colloidal silica, hydroxyapatite etc. can also be used.

Dispersion droplets of the resin particles mentioned earlier can also be stabilized as the dispersing agent that can be used in combination with the inorganic compound dispersing agent by using a polymeric protecting colloid. Examples of the polymeric protecting colloids that can be used are acids such as acrylic acid, methacrylic acid, α-cyanoacrylic acid, α-cyanomethacrylic acid, itaconic acid, crotonic acid, fumaric acid, maleic acid or maleic anhydride, methacrylic monomers that include a hydroxyl group, for example, acrylic acid-β-hydroxyethyl, methacrylic acid-β-hydroxyethyl, acrylic acid-β-hydroxypropyl, methacrylic acid-β-hydroxypropyl, acrylic acid-γ-hydroxypropyl, methacrylic acid-γ-hydroxypropyl, acrylic acid-3-chloro-2-hydroxypropyl, methacrylic acid-3-chloro-2-hydroxypropyl, diethylene glycol monoacrylic acid ester, diethylene glycol monomethacrylic acid ester, glycerin monoacrylic acid ester, glycerin mono methacrylic acid ester, N-methylol acrylic amide, N-methylol methacrylic amide etc., vinyl alcohol or ethers with vinyl alcohol, for example, vinyl methyl ether, vinyl ethyl ether, vinyl propyl ether etc., esters of compounds that include a vinyl alcohol and a carboxyl group, for example, vinyl acetate, vinyl propionate, vinyl butyrate etc., acrylic amide, methacrylic amide, diacetone acrylic amide or methylol compounds of acrylic amide, methacrylic amide, and diacetone acrylic amide, acid chlorides such as chloride acrylate, methacrylic chloride, nitrogen containing compounds, for example, vinyl pyridine, vinyl pyrrolidone, vinyl imidazol, ethyleneimine etc. or heterocyclic homopolymers or copolymers of the nitrogen containing compounds, polyoxyethylenes, for example, polyoxyethylene, polyoxypropylene, polyoxyethylene alkylamine, polyoxypropylene alkyl amine, polyoxyethylene alkyl amide, polyoxypropylene alkyl amide, polyoxyethylene nonylphenyl ether, polyoxyethylene laurylphenyl ether, polyoxyethylene stearylphenyl ester, polyoxyethylene nonylphenyl ester etc., and celluloses, for example, methyl cellulose, hydroxy ethyl cellulose, hydroxy propyl cellulose etc.

The dispersion method is not limited to any specific method, and commonly known methods such as a low speed shearing method, a high speed shearing method, a friction method, a high pressure jet method can be applied. The high speed shearing method is desirable for ensuring a particle diameter of 2 to 20 (μm) for a dispersion element. When using a high speed shearing method dispersing device, although a number of revolutions is not limited to a specific number, the number of revolutions is normally 1000 to 30000 revolutions per minute (rpm), and a number of 5000 to 20000 (rpm) is desirable. Although a dispersion time period is not limited to a specific time period, when using a batch method, the dispersion time period is normally 0.1 to 5 minutes. Normally, the dispersion is carried out at a temperature of 0° to 150° C. (under pressure) and a temperature of 40° to 98° C. is desirable.

Next, along with preparation of an emulsified liquid, the amines (B) are simultaneously added and the emulsified liquid is caused to react with the polyester prepolymer (A) that includes an isocyanate group.

During the reaction mentioned earlier, the molecular chain is subjected to any one of the crosslinking reaction or the elongation reaction or both. Although a reaction time period is selected based on a reactivity of an isocyanate group structure included in the polyester prepolymer (A) with the amines (B), the reaction time period is normally 10 minutes to 40 hours, and a reaction time period of 2 to 24 hours is desirable. A reaction temperature is normally 0° C. to 150° C. and a reaction temperature of 40° C. to 98° C. is desirable. A commonly known catalyst can be used if required. To be specific, a catalyst such as dibutyltin laurate or dioctyltin laurate can be used.

After completion of the reaction, the organic solvent is removed from the emulsified dispersion element (reaction product) and the reaction product is cleaned and dried to get the parent toner particles.

For removing the organic solvent, the temperature is gradually increased while stirring a laminar flow of the entire reaction product. After strongly stirring the reaction product at a fixed temperature range, the organic solvent is removed and the spindle shaped parent toner particles can be formed. Further, if a chemical such as a calcium phosphate salt which is soluble in acids and alkalies is used as a dispersion stabilizer, the calcium phosphate salt is dissolved using an acid such as hydrochloric acid and the resulting solution is washed with water to remove the calcium phosphate salt from the toner particles. Further, the calcium phosphate salt can also be removed using an operation such as enzymatic breakdown.

The electric charge controller is added to the parent toner particles that are obtained using the method mentioned earlier, and the inorganic particles such as silica particles and titanium oxide particles are externally added to get the toner.

Addition of the electric charge controller and external addition of the inorganic particles is carried out by a commonly known method that uses a mixer.

Due to this, the toner having a small particle diameter and a sharp particle diameter distribution can be easily obtained. Further, due to strong stirring during the process to remove the organic solvent, a shape of the toner particles can be controlled to a shape between a spherical shape and a rugby ball shape. Further, a surface morphology of the toner particles can also be controlled to between smooth and corrugated.

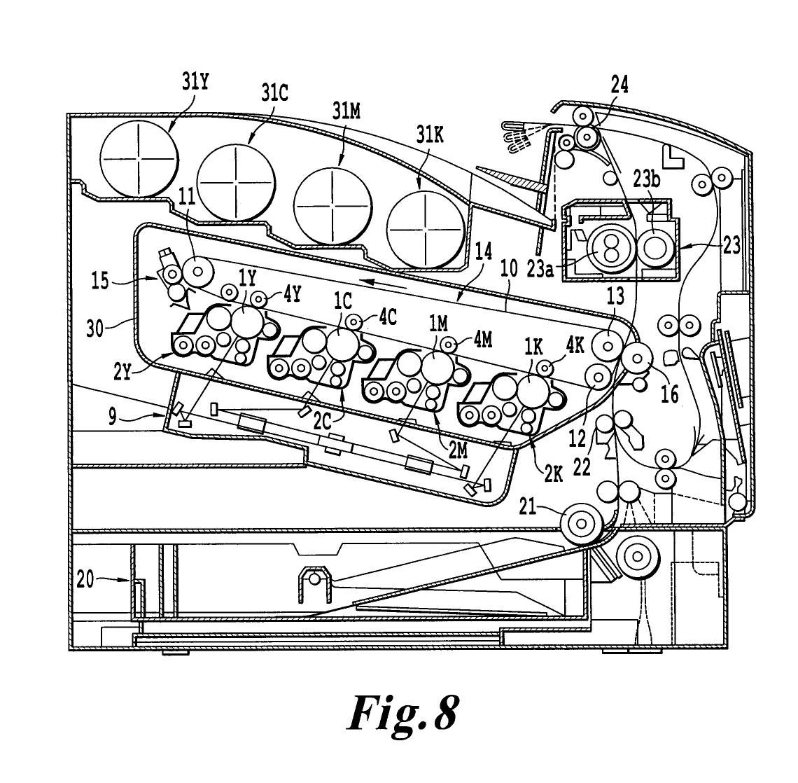

A structure and an operation of the image forming apparatus that uses the present invention are explained next. FIG. 8 is a schematic of an overview of the image forming apparatus. The image forming apparatus shown in FIG. 8 is a tandem color image forming apparatus. An intermediate transferring unit 14 is arranged in a central portion of the image forming apparatus. The intermediate transferring unit 14 includes the transfer belt 10 as an intermediate transfer body that moves endlessly in a direction of the arrow shown in FIG. 8. Four image forming units 2Y, 2C, 2M, and 2K which form a yellow toner image, a cyan toner image, a magenta toner image, and a black toner image respectively are arranged on a lower stretched surface of the transfer belt 10. The reference symbols Y, C, M, and K, which are affixed to the numeral 2 of the image forming units, correspond respectively to yellow, cyan, magenta, and black colors of the toner. In the tandem image forming apparatus, the image forming units 2Y, 2C, 2M, and 2k respectively include photosensitive drums 1Y, 1C, 1M, and 1K as latent image bearing members. A charger and a developing device, which are explained later, are arranged around each of the photosensitive drum 1Y, 1C, 1M, and 1K. An exposure device 9 which carries out light emission on the photosensitive drums 1Y, 1C, 1M, and 1K and forms electrostatic latent images on the photosensitive drums 1Y, 1C, 1M, and 1K is arranged on a lower side of the image forming units 2Y, 2C, 2M, and 2K.

The exposure device 9 uses light corresponding to image data of each color to scan the surface of the photosensitive drums 1 that are charged uniformly by the chargers to form the electrostatic latent images. The exposure device 9 uses a laser beam and a polygon mirror. The exposure device 9 can use a laser scanning method, which uses a beam of light that is modulated according to the image data to be formed, or a method in which an array of light emitting diodes (LED) and image forming elements are used as luminous elements.

The transfer belt 10 is supported by a plurality of rollers 11, 12, and 13 and runs in the direction of the arrow. The transfer belt 10 is stretched and arranged such that a portion of the photosensitive drums 1Y, 1C, 1M, and 1K that have passed the developing devices touches the transfer belt 10. Further, primary transferring rollers 4Y, 4C, 4M, and 4K are arranged opposite the photosensitive drums 1Y, 1C, 1M, and 1K on the inner periphery of the transfer belt 10. A belt cleaner 15 is arranged on an outer periphery of the transfer belt 10 at a position opposite the roller 11. The belt cleaner 15 cleans the unnecessary toner or scraps of paper etc. that remain on the surface of the transfer belt 10. Components related to the transfer belt 10 are integrally structured as the intermediate transferring unit 14 that can be detached from the image forming apparatus. Further, a secondary transferring roller 16 is arranged on the outer periphery of the transfer belt 10 in the vicinity of the supporting roller 13. A bias is applied to the secondary transferring roller 16 while passing a recording medium (hereinafter, “sheet P”) between the transfer belt 10 and the secondary transferring roller 16. Due to this, the toner image borne by the transfer belt 10 is transferred to the sheet P. A polarity of a transfer electric current, which is applied to the secondary transferring roller 16, is opposite to the polarity of the toner, in other words, positive.

A sheet feeder 20, which stores therein sheets such that the sheets can be supplied to the image forming apparatus, is arranged on a lower side of the image forming apparatus. A transporting roller 21 transmits only a single sheet to a resist roller 22.

The sheet that has passed the secondary transferring roller 16 is transmitted to a fixing device 23 that is arranged at a lower stream side in a transporting direction of the recording medium. The fixing device 23 includes a heating unit. A belt fixing device, which includes a heater inside a roller and runs a belt that is heated can be used as the fixing device 23. A fixing device, which uses induction heating as a heating method, can also be used as the fixing device 23. Based on whether the image is a full color image or a monochromatic image and whether the image is on a single surface or both the surfaces of the sheet, the fixing device 23 controls fixing conditions and causes a not shown controller to exercise control such that the image is fixed under the optimum fixing conditions according to a type of the sheet. After fixing, a sheet ejecting roller 24 ejects and stacks the sheet in an ejected sheet-stacking tray that is arranged in an upper portion of the image forming apparatus.

Toner cartridges 31Y, 31C, 31M, and 31K, which store therein unused toner, are detachably housed in a space on the upper portion of the intermediate transferring unit 14. A not shown toner transporting unit such as a mono pump or an air pump supplies the toner to each developing device according to necessity. Especially, a storage capacity of the toner cartridge 31K, which is used for housing the black toner that is significantly consumed, can also be increased.

The image forming units 2Y, 2C, 2M, and 2K are explained next. Because the image forming units 2Y, 2C, 2M, and 2K include the same structure and carry out the same operation, the accompanying symbols Y, C, M, and K of each reference numeral are omitted and the image forming unit 2 is explained in detail. FIG. 9 is a schematic of an overview of the image forming unit 2. A charging roller 3 as a charging device, a developing device 5, the light source 6, a transparent electrode 7, and a recycling brush 8 are sequentially arranged around the photosensitive drum 1 that rotates in a clockwise direction. Further, the primary transferring roller 4 is arranged on an inner side of the transfer belt 10 opposite the downstream side of the developing device 5.

The photosensitive drum 1 is a drum shaped component in which a photoconductive material such as an organic photosensitive layer (OPC) is formed on an aluminum cylindrical surface having a diameter of 30 to 120 (mm). A photosensitive drum, which includes an amorphous silicon (a-Si) layer, can also be used. Further, a belt shaped photosensitive drum can also be used.

The charging device includes the charging roller 3 as a charging member. The charging roller 3 is positioned such that the charging roller 3 touches or proximally approaches the photosensitive drum 1. Applying a voltage to the charging roller 3 uniformly charges the surface of the photosensitive drum 1.

The developing device 5 includes the developing roller 5a as a developer bearing member that is positioned proximally opposite to the surface of the photosensitive drum 1 and a stirring and transporting screw 5b that stirs and transports the housed developer. The developing roller 5a bears the bicomponent developer that is housed inside the developing device 5, transports the bicomponent developer to a position opposite the photosensitive drum 1, and supplies the toner to the electrostatic latent image on the photosensitive drum 1, thus developing the electrostatic latent image. In a reversal developing carried out in the present embodiment, the electrostatic latent image which is formed due to emission of the laser beam on the negatively charged OPC photosensitive drum 1 is developed using the toner of a predetermined color having the same polarity (negative polarity) as the charge polarity of the photosensitive drum 1. Thus, the electrostatic latent image is converted into a developed image.

The light source 6 and the transparent electrode 7 form an electrostatic charge-controlling unit for controlling a toner charge by using the optical switch phenomenon that is a salient feature of the present embodiment. The light source 6 and the transparent electrode 7 are explained in detail later.

A bias of a polarity opposite to the toner charge polarity is applied to the recycling brush 8. The recycling brush 8 electrostatically removes the transfer residual toner from the surface of the photosensitive drum 1.

The image forming units 2Y, 2C, 2M, and 2K are integrally formed as process cartridges that can be detached from a main body of a printer. The process cartridges can be pulled from the main body of the printer along a not shown guiding rail that is fixed to the main body of the printer. Further, pushing the cartridges into the main body of the printer enables to mount the image forming units 2Y, 2C, 2M, and 2K at a predetermined position.

An operation, which is performed by the image forming apparatus that includes the structure mentioned earlier, to form the full color image is explained next. In the present embodiment, because the image forming apparatus includes the structure mentioned earlier, when transferring the image that is borne on the transfer belt 10 to the sheet, the image is formed on a lower surface of the sheet to ensure that sheets are assembled on the ejected sheet stalking tray even if data for recording necessitates a plurality of sheets. Upon activating the image forming apparatus, the photosensitive drums 1Y, 1C, 1M, and 1K in the image forming units 2Y, 2C, 2M, and 2K respectively turn and the image forming units 2Y, 2C, 2M, and 2K start image formation. Due to an operation of the exposure device 9, which drives the laser beam and the polygon mirror, light corresponding to the image data for yellow color is emitted on the surface of the photosensitive drum 1Y that is uniformly charged by the charging roller 3, thus forming the electrostatic latent image. The developing roller 5a develops the electrostatic latent image using the yellow toner to form a visual image. Due to a transfer operation of the primary transferring roller 4Y, the visual image is electrostatically primary transferred on the transfer belt 10 that moves in synchronization with the photosensitive drum 1Y. Similarly, such an operation, which includes latent image formation, development, and primary transfer, is also carried out sequentially for the photosensitive drums 1C, 1M, and 1K at appropriate timings. Due to this, the toner images of yellow, cyan, magenta, and black colors are borne on the transfer belt 10 as the sequentially overlapped full color image and move in the direction of the arrow along with the transfer belt 10.

Simultaneously, the sheet P, which is used for recording the image, is sent out and transported by the transporting roller 21 that supplies the sheets from a feeding cassette inside the sheet feeder 20. The resist roller 22 rotates at a timing when a tip of the sheet P has reached the resist roller 22 and transports the sheet P to a transfer area. Upon receiving the transfer operation performed by the secondary transferring roller 16, the full color image on the transfer belt 10 is transferred on the upper surface of the sheet P that is transported in synchronization with the transfer belt 10. The bias applied to the secondary transferring roller 16 is of the positive polarity that is a reverse polarity with respect to the toner polarity. According to a type of the image forming apparatus, the image can also be transferred by applying a bias of the same polarity as the toner polarity to the roller 13 on the inner side of the transfer belt 10. Next, the belt cleaner 15 cleans the surface of the transfer belt 10.

The sheet P, which includes the transferred toner images that are overlapped and borne on the transfer belt 10, is transported towards the fixing device 23. The toner of each color that is overlapped on the sheet P is subjected to a fixing operation due to heat of the fixing device 23, fuses, and the colors mix to form the completed color image. Based on a type of the image, power used by the fixing device is optimally controlled by a controlling unit. Because even the fixed toner is likely to be scraped by guide members of a transport path, thus causing omissions or deterioration of the image, the sheet needs to be transported carefully even after fixing the image until the fixed toner completely adheres to the sheet. Next, the sheet ejecting roller 24 ejects the sheet P to the ejected sheet-stacking tray such that an image bearing surface of the sheet P is facing downwards. Because the sheets in the ejected sheet-stacking tray are stacked such that a recorded material of the following sheet is stacked sequentially, the sheets are assembled in a sequential order.

The transfer residual toner which is not transferred remains on the surface of each photosensitive drum 1 in the image forming unit 2 that has completed the primary transfer. Generally the transfer residual toner includes a significant amount of the reverse polarity component.

Recently, for enhancing cost effectiveness and environmental compatibility of the image forming apparatus, a cleanerless system is used that reuses without cleaning, the transfer residual toner that remains on the photosensitive drum 1 after transfer. In the cleanerless system, upon applying the bias to the charging roller 3 that is positioned to touch or proximally approach the photosensitive drum 1, the charging roller 3 adsorbs the reverse polarity toner from the transfer residual toner, thus causing occurrence of inconsistent electrostatic charge. To avoid the drawback, a toner charge-controlling unit is necessitated that reverts to the regular charge polarity, the reversely charged toner that adheres on the photosensitive drum 1 and the charging roller 3.

The toner, which remains on the surface of the photosensitive drum 1 in the image forming unit 2 that has completed the primary transfer, simultaneously receives the bias that is applied from the transparent electrode 7 and light that is emitted from the light source 6 via the transparent electrode 7, thereby causing occurrence of the optical switch phenomenon mentioned earlier and occurrence of the electric charge injection. Due to this, the electrostatic charge of the toner is controlled by the optical bias. The recycling brush 8, which is subjected to application of the reverse polarity bias with respect to the polarity of the electric charge injection, effectively removes the toner from the surface of the photosensitive drum 1. By applying a bias, at a fixed timing after completion of the image formation, of a reverse polarity with respect to the toner polarity at the time of recycling by the recycling brush 8, the toner that is recycled by the recycling brush 8 is poured on the photosensitive drum 1. The toner passes the charging roller 3, is recycled by the developing device 5, and reused. When recycling the toner, a separate positioning of the charging roller 3 from the photosensitive drum 1 is desirable.

Next, the toner charge-controlling unit, which uses the optical bias control used in the present embodiment, and the cleanerless system are explained in detail. Along with rotations of the photosensitive drum 1, the toner, which is not transferred to the transfer belt 10 by the first transferring roller 4, is transmitted to a portion opposite the recycling brush 8. The transparent electrode 7 and the light source 6 that carries out light emission on the toner via the transparent electrode 7 are positioned at a further upstream portion compared to the recycling brush 8. The transparent electrode 7 touches the photosensitive drum 1 by using the power of a spring or elasticity of the transparent electrode 7 itself. The transfer residual toner on the photosensitive drum 1 simultaneously receives the electric field that is applied between the transparent electrode 7 and the photosensitive drum 1 and light that is emitted from the light source 6 and that is transmitted via the transparent electrode 7. Further, a touching surface of the transparent electrode 7 is pressed against the photosensitive drum 1. Due to this, when passing a wedge portion that is formed between the transparent electrode 7 and the photosensitive drum 1, the transfer residual toner is thinned and simultaneously evened out uniformly. The toner is uniformly evened out further effectively if the transparent electrode 7 is oscillating in a drum axial direction of the photosensitive drum 1. Due to this, all the transfer residual toner on the photosensitive drum 1 can uniformly receive the applied electric field and the light. Thus, the electric charge injection into all the transfer residual toner is carried out stably and reliably. Further, a not shown controller controls the applied electric field and the amount of light and controls the strength of the electric field and the intensity of the light according to environmental conditions and the amount of the transfer residual toner. In the optical bias control, because the electric charge is controlled also by using light emission instead of using only the voltage application, electric charge control of the toner can be realized by applying comparatively low voltage.

The transfer residual toner simultaneously receives the light emission and the applied electric field. Thus, the polarity and the electric charge amount, which are necessary for recycling of the toner by the recycling brush 8, are charge injected into the toner and the toner is uniformly thinned. The transfer residual toner is easily collected by the recycling brush 8 due to the electric field that is applied between the recycling brush 8 and the photosensitive drum 1 and that includes a reverse polarity with respect to the toner. The electric field, which is applied to the recycling brush 8, is also controlled according to the environmental conditions, the amount of the remaining toner, the electric charge amount that is injected into the toner etc.

Generally, the image formation is repeated under the conditions mentioned earlier. However, the recycled toner gradually accumulates in the recycling brush 8 and exceeds a permitted amount. Due to this, the toner needs to be discharged from the recycling brush 8 at a fixed timing (after several tens or hundreds of sheets) before the recycling brush 8 has reached a limit of toner storage capacity. When discharging the toner, an electric field, which includes a reverse polarity with respect to the polarity of the electric field applied at the time of recycling, is applied to the recycling brush 8 during a non imaging period such as upon completion of a job and the toner is discharged from the recycling brush 8 on the photosensitive drum 1. Along with the rotations of the photosensitive drum 1, the discharged toner reaches the developing device 5 via the charging roller 3. The discharged toner is recycled due to a torque of a magnetic brush of the developing roller 5a and incorporated inside the developing device 5. When discharging the toner from the recycling brush 8, a separation of the charging roller 3 from the photosensitive drum 1 is desirable if the charging roller 3 is not a noncontact type roller (is a contact type roller). However, a damage caused due to the discharged toner can be minimized by either attaching a (not shown) brush having a sufficient cleaning ability to the charging roller 3 or by applying to the charging roller 3, a weak electric field that includes a reverse polarity with respect to the toner and that does not cause electrical discharge.

Further, when recycling the toner using the developing device 5, the toner is recycled by a physical scraping force of the magnetic brush due to the rotations of the developing roller 5a, thus removing a necessity of applying the electric field to the developing roller 5a especially for recycling the toner. When applying the electric field, a normal developing bias can be applied based on a relation between the recycled toner and the toner polarity inside the developing device 5. Thus, the toner, which is recycled inside the developing device 5, is stirred and mixed by the stirring and transporting screw 5b, the toner polarity is uniformized by the frictional electrostatic charge, and the toner is reused for development.

If the reverse polarity toner is adhering to the charging roller 3, an electroconductive member which is subjected to application of a bias voltage is brought into contact with the charging roller 3 and the reverse polarity toner is simultaneously subjected to light emission. Due to this, the optical switch phenomenon occurs in the toner and the electrostatic charge amount of the toner can be reverted to the regular charge polarity. Thus, occurrence of unevenness in the electrostatic charge can be prevented.

If a structure is enabled in which the electroconductive member subjected to application of the bias voltage is brought into contact with the toner and light is emitted on the toner, the electrostatic charge amount of the toner can be controlled to a desired value by causing the occurrence of the optical switch phenomenon in the toner even at other places in the image forming apparatus.

In the present embodiment, the transparent electrode 7, which is subjected to application of the bias voltage, is brought into contact with the insulating toner and simultaneously light is emitted on the insulating toner using the light source 6. Thus, the electrostatic charge amount of the insulating toner can be controlled by causing the occurrence of the optical switch phenomenon in the insulating toner.

In the present invention, upon applying a voltage to an insulating toner and simultaneously subjecting the insulating toner to light emission, a new phenomenon is detected in which an electric charge injection occurs in the insulating toner and an electric charge of the insulating toner changes. The new phenomenon is used to control the electric charge of the toner. Hereinafter, the phenomenon mentioned earlier is called “optical switch phenomenon” and differentiated from commonly known photoconductivity. Photoconductivity indicates using light emission to ensure a low resistance of the toner and the low resistance is used to reduce an electric charge amount of the toner. The electric charge injection is also likely to occur upon applying the voltage. However, in the optical switch phenomenon, the toner electric charge does not change only due to light emission (in other words, the optical switch phenomenon differs from the photoconductivity). As indicated by experiments that are explained later, carrying out light emission simultaneously with application of the voltage causes the electric charge injection and changes the electric charge amount of the toner. Using the optical switch control, an electrostatic charge amount of the insulating toner can be controlled by carrying out application of the voltage and simultaneous light emission. Hereinafter, such a control is called “optical bias control”.

As described above, according to one aspect of the present invention, an optical bias control method related to a non-photoconductive insulating toner and an image forming apparatus that uses the optical bias control method can be provided. In the optical bias control method, using light emission and voltage application enables to control an electric charge of the insulating toner.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A method of controlling an electric charge amount of an insulating toner, comprising:
causing an optical switch phenomenon in which an electrostatic charge amount of the insulating toner changes, by irradiating the insulating toner with a light, while making the insulating toner contact with a photoconductive member to which a bias voltage is applied.

2. An image forming apparatus comprising:
an electric-charge control unit that includes
a bias voltage-applying unit that applies a bias voltage to an insulating toner that includes an electric charge, by making a contact with the insulating toner, and
a light irradiating unit that irradiates the insulating toner with a light, wherein
the electric-charge control unit controls an electric charge amount of the insulating toner by causing an optical switch phenomenon in which an electrostatic charge amount of the insulating toner changes, by irradiating the insulating toner with the light using the light irradiating unit while applying the bias voltage to the insulating toner using the bias voltage-applying unit.

3. An image forming apparatus comprising:
an electric-charge control means that includes
a bias voltage-applying means for applying a bias voltage to an insulating toner that includes an electric charge, by making a contact with the insulating toner, and
a light irradiating means for irradiating the insulating toner with a light, wherein
the electric-charge control means controls an electric charge amount of the insulating toner by causing an optical switch phenomenon in which an electrostatic charge amount of the insulating toner changes, by irradiating the insulating toner with the light using the light irradiating means while applying the bias voltage to the insulating toner using the bias voltage-applying means.
